(19) United States
(12) Patent Application Publication
(10) Pub. No.: US 2025/0147456 A1
(43) Pub. Date: May 8, 2025

(54) DEVELOPER SUPPLY CONTROL DEVICE AND IMAGE FORMING DEVICE

(71) Applicant: Zhuhai Pantum Electronics Co., Ltd., Zhuhai (CN)

(72) Inventors: Zhijin CAI, Zhuhai (CN); Ruiqi LIN, Zhuhai (CN); Zhihao LI, Zhuhai (CN)

(21) Appl. No.: 18/937,140

(22) Filed: Nov. 5, 2024

(30) Foreign Application Priority Data
Nov. 6, 2023 (CN) 202311469477.X
Dec. 25, 2023 (CN) 202311793547.7

(51) Int. Cl. G03G 15/00; G03G 15/08

(52) U.S. Cl. CPC G03G 15/50; G03G 15/0891

(57) ABSTRACT

A developer supply control device includes: an imaging component; a developer transmission channel for connecting a developer containing device and the imaging component; a developer transmission component, at least partially disposed in the developer transmission channel to transmit developer to the imaging component; a residual information feedback unit, used to send residual information of the developer in the imaging component to an image forming device, where the residual information of the developer is used to determine whether the developer needs to be supplied to the imaging component; and a state detection unit, used to detect a working state of the developer transmission component. When the image forming device acquires the working state information, the residual information of the developer and the working state information are used to determine whether to control the developer containing device to supply the developer to the developer transmission channel.

### CROSS-REFERENCE TO RELATED APPLICATION

This application claims the priority of Chinese Patent Application No. 202311469477.X, filed on Nov. 6, 2023, and the priority of Chinese Patent Application No. 202311793547.7, filed on Dec. 25, 2023, the contents of all of which are incorporated herein by reference in their entirety.

### TECHNICAL FIELD

The present disclosure generally relates to the field of image forming technologies and, more particularly, relates to a developer supply control device and an image forming device.

### BACKGROUND

With the development of printing and imaging technologies, image forming devices such as printers, copiers, fax machines, word processors, etc. have been widely used. An image forming device usually includes a developer containing device (such as an ink cartridge, a powder cartridge, a developer cartridge, a toner cartridge, etc.) and an imaging component. The developer containing device can supply the developer (such as ink, toner, etc.) in the developer containing device to the imaging component. The imaging component includes a photosensitive drum, a charging component, and a developing component. The charging component can make the surface of the photosensitive drum uniformly charged such that the uniformly charged surface of the photosensitive drum carries an electrostatic latent image, and the electrostatic latent image is developed by the developing component and the developer to form an image.

A developer transmission channel is provided between the developer containing device and the imaging component, and a developer transmission component is provided in the developer transmission channel. When the developer in the imaging component is consumed, the developer containing device can supply the developer therein to the developer transmission channel, and then the developer transmission component transmits the developer in the developer transmission channel to the imaging component, replenishing the developer for the imaging component to ensure the normal operation of the imaging component.

However, in actual applications, because of the lack of precise control over the developer supply, the amount of developer supplied to the imaging component is not fixed, and the developer is unevenly and unstably distributed in the imaging component, which in turn causes defects such as white spots or color spots in the image, and even causes polymers to appear in the developer of the imaging component.

### SUMMARY

One aspect of the present disclosure provides a developer supply control device. The device includes: an imaging component; a developer transmission channel for connecting a developer containing device and the imaging component; a developer transmission component, at least partially disposed in the developer transmission channel and used to transmit developer in the developer transmission channel supplied from the developer containing device to the imaging component; a residual information feedback unit, used to send residual information of the developer in the imaging component to an image forming device, where the residual information of the developer is used to determine whether the developer needs to be supplied to the imaging component; and a state detection unit, used to detect a working state of the developer transmission component. When the image forming device acquires the working state information, the residual information of the developer and the working state information are used to determine whether to control the developer containing device to supply the developer to the developer transmission channel.

Another aspect of the present disclosure provides an image forming device. The image forming device includes a main body and a developer supply control unit. The main body includes a frame and a containing chamber. The containing chamber is used to accommodate a developer containing device and a developer supply control device. The developer supply control device includes: an imaging component; a developer transmission channel for connecting the developer containing device and the imaging component; a developer transmission component, at least partially disposed in the developer transmission channel and used to transmit developer in the developer transmission channel supplied from the developer containing device to the imaging component; a residual information feedback unit, used to send residual information of the developer in the imaging component to the image forming device, where the residual information of the developer is used to determine whether the developer needs to be supplied to the imaging component; and a state detection unit, used to detect a working state of the developer transmission component. When the image forming device acquires the working state information, the residual information of the developer and the working state information are used to determine whether to control the developer containing device to supply the developer to the developer transmission channel. The developer supply control unit is used to control the developer containing device to supply the developer to the developer transmission channel based on residual information of the developer in the imaging component and working state information of the developer transmission component of the developer supply control device.

Another aspect of the present disclosure provides a developer supply control device. The device includes: an imaging component; a developer transmission channel for connecting a developer containing device and the imaging component; a developer transmission component, at least partially disposed in the developer transmission channel and used to transmit the developer in the developer transmission channel supplied from the developer containing device to the imaging component; a residual information feedback unit, used to send residual information of the developer in the imaging component to an image forming device, where the residual information of the developer being used to determine whether the developer needs to be supplied to the imaging component; and a state detection unit installation area, used to install a state detection unit. The state detection unit is used to detect a working state of the developer transmission component, and when the image forming device acquires the working state information, the residual information of the developer and the working state information are used to determine whether to control the developer containing device to supply the developer to the developer transmission channel.

### BRIEF DESCRIPTION OF THE DRAWINGS

The following drawings are merely examples for illustrative purposes according to various disclosed embodiments and are not intended to limit the scope of the present disclosure.

FIG. 1 illustrates a three-dimensional structure of an exemplary image forming device according to various disclosed embodiments of the present disclosure.

FIG. 2 illustrates a structure of an exemplary image forming device according to various disclosed embodiments of the present disclosure.

FIG. 3 illustrates a cooperative relationship of a developer containing device and an imaging component according to various disclosed embodiments of the present disclosure.

FIG. 4 illustrates a local structure of a developer containing device and an imaging component according to various disclosed embodiments of the present disclosure.

FIG. 5 illustrates a structure of an exemplary developer supply control device according to various disclosed embodiments of the present disclosure.

FIG. 6 illustrates a three-dimensional structure of a developer transmission component according to various disclosed embodiments of the present disclosure.

FIG. 7 illustrates a three-dimensional structure of a driving member according to various disclosed embodiments of the present disclosure.

FIG. 8 illustrates a three-dimensional structure of a toggle member according to various disclosed embodiments of the present disclosure.

FIG. 9 illustrates a three-dimensional structure of a developer carrier ratio sensor according to various disclosed embodiments of the present disclosure.

FIG. 10 illustrates a three-dimensional structure of another developer transmission component according to various disclosed embodiments of the present disclosure.

FIG. 11 illustrates a principle schematic diagram of working state detection according to various disclosed embodiments of the present disclosure.

FIG. 12 illustrates a structure of installing an adapter according to various disclosed embodiments of the present disclosure.

FIG. 13 illustrates a structure of a developer transmission component and a protection unit according to various disclosed embodiments of the present disclosure.

FIG. 14 illustrates a cooperative relationship of a developer transmission component and a protection unit according to various disclosed embodiments of the present disclosure.

FIG. 15 illustrates a structure of a protection unit according to various disclosed embodiments of the present disclosure.

FIG. 16 illustrates a waveform diagram of a residual information detection signal according to various disclosed embodiments of the present disclosure.

FIG. 17 illustrates a structure of a photoelectric sensor according to various disclosed embodiments of the present disclosure.

FIG. 18 illustrates a waveform diagram of a working state detection signal according to various disclosed embodiments of the present disclosure.

FIG. 19 illustrates a structure of a cartridge according to various disclosed embodiments of the present disclosure.

FIG. 20 illustrates a structure of an image forming device according to various disclosed embodiments of the present disclosure.

FIG. 21 illustrates a structure of a developer supply control unit according to various disclosed embodiments of the present disclosure.

FIG. 22 illustrates a structure of another developer supply control unit according to various disclosed embodiments of the present disclosure.

FIG. 23 illustrates a structure of a first driving unit and a second driving unit according to various disclosed embodiments of the present disclosure.

FIG. 24 illustrates a flowchart of an exemplary developer supply control method according to various disclosed embodiments of the present disclosure.

FIG. 25 illustrates a flowchart of another exemplary developer supply control method according to various disclosed embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. The embodiments disclosed herein are exemplary only. Other applications, advantages, alternations, modifications, or equivalents to the disclosed embodiments are obvious to those skilled in the art and are intended to be encompassed within the scope of the present disclosure.

It should be noted that the terms used in the embodiments of the present disclosure are only for the purpose of describing specific embodiments, and are not intended to limit the scope of the present disclosure. As used in the embodiments of the present disclosure and the appended claims, the singular forms such as “a”, “said” and “the” are also intended to include the plural forms unless the context clearly indicates otherwise.

It should be understood that the term “and/or” used in this specification is just for relationship description of related objects, indicating that there can be three kinds of relationships. For example, A and/or B, which can mean that A exists alone, A and B exist at the same time, and B exists alone. In addition, the character “/” in this specification generally indicates that the related objects are in an “or” relationship.

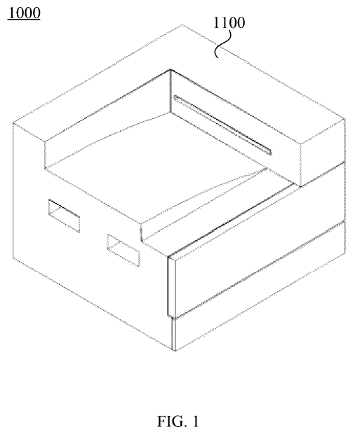

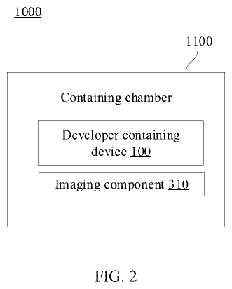

As shown in FIG. 1 which is a schematic diagram of a three-dimensional structure of an image forming device provided by the present disclosure and FIG. 2 which is a block diagram of an image forming device provided by the present disclosure, the image forming device 1000 may include a body 1100, and the body 1100 may include a frame (an outer shell of the body 1100) and a containing chamber 1110. A developer containing device 100 (such as an ink cartridge, a powder box, a powder cartridge, a toner cartridge, etc.) and an imaging component 310 may be disposed in the containing chamber 1110. The developer containing device 100 may be used to accommodate the developer (such as ink, toner, etc.), and the developer in the developer containing device may be supplied to the imaging component 310. The imaging component 310 may include a photosensitive drum, a charging component, a developing component, etc. The charging component may charge the surface of the photosensitive drum uniformly, such that the uniformly charged surface of the photosensitive drum carries an electrostatic latent image, and the electrostatic latent image may be developed by the developing component and the developer, thereby forming an image.

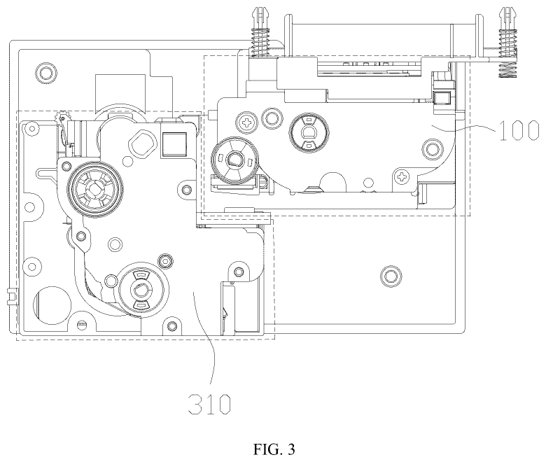

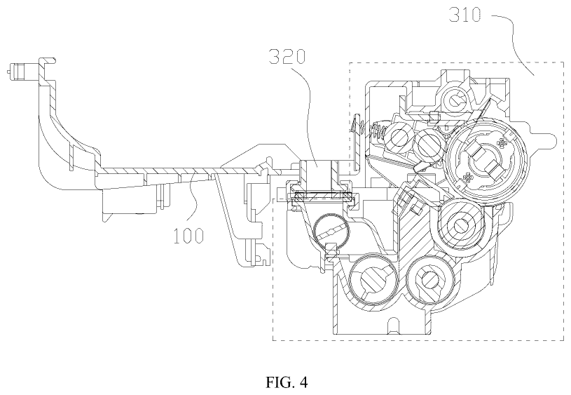

As shown in FIG. 3 which is a schematic diagram of the cooperative relationship between the developer containing device and the imaging component provided by the present disclosure and FIG. 4 which is a schematic diagram of the partial structure of a developer containing device and an imaging component provided by the present disclosure, a developer transmission channel 320 may be provided between the developer containing device 100 and the imaging component 310, and a developer transmission component 330 (not shown in the figure) may be provided in the developer transmission channel 320. When the developer in the imaging component 310 is consumed, the developer containing device 100 may supply the developer in the developer containing device 100 to the developer transmission channel 320, and then the developer transmission component 330 may transmit the developer in the developer transmission channel 320 to the imaging component 310, replenishing the developer for the imaging component 310 to ensure the normal operation of the imaging component 310.

In actual applications, because of the lack of precise control over the developer supply, the amount of developer supplied to the imaging component 310 may be not fixed, and the developer may be unevenly and unstably distributed in the imaging component 310, which in turn causes defects such as white spots or color spots in the image formed and even causes the developer in the imaging component 310 to polymerize and generate polymers.

The present disclosure provides a developer supply control device to at least partially alleviate the above problem. In the present disclosure, the developer supply control device may include a developer transmission component, a residual information feedback unit and a state detection unit. The residual information feedback unit may send the residual information of the developer in the imaging component to the image forming device, and the state detection unit may detect the working state of the developer transmission component and send the detected working state information to the image forming device. Based on the residual information of the developer and working state information, the image forming device may determine whether to control the developer containing device to supply the developer to the developer transmission channel, to achieve precise control of the developer supply amount, such that the developer is able to stably and evenly enter the imaging component. Consequently, the image quality of the image forming device may be improved and the polymerization of the developer in the imaging component may be prevented.

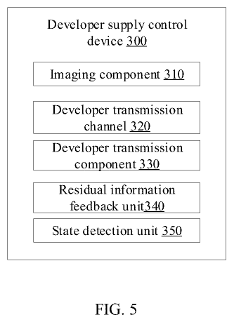

In one embodiment shown in FIG. 5 which is a structure of a developer supply control device provided by the present disclosure, the developer supply control device 300 may include an imaging component 310, a developer transmission channel 320 and a developer transmission component 330. The developer transmission channel 320 may be used to connect the developer containing device 100 and the imaging component 310. The developer transmission component 330 may be arranged in the developer transmission channel 320 (that is, partially or entirely arranged in the developer transmission channel 320). The developer transmission component 330 may transmit the developer in the developer transmission channel 320 supplied by the developer containing device 100 to the imaging component 310.

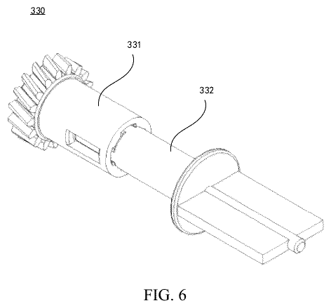

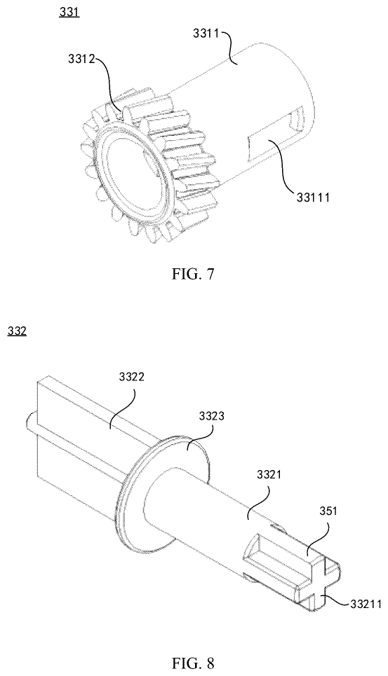

As shown in FIG. 6 to FIG. 8, in one embodiment, the developer transmission component 330 may include a driving member 331 and a toggle member 332. The driving member 331 may be used to receive the driving force of the image forming device 1000, and the toggle member 332 may be connected to the driving member 331. The toggle member 332 may be used to rotate under the drive of the driving member 331, and toggle the developer in the developer transmission channel 320, such that the developer in the developer transmission channel 320 is transmitted to the imaging component 310.

The driving member 331 may include a first driving gear 3312, and the first driving gear 3312 may be used to mesh with other gears in the image forming device 1000 to receive the driving force provided by the other gears in the image forming device 1000, such that the driving member 331 rotates. Exemplarily, in one embodiment, the first driving gear 3312 may mesh with the gear in the imaging component 310. When the imaging component 310 is driven, the imaging component 310 may drive the first driving gear 3312 to rotate, thereby rotating the driving member 331. Of course, those skilled in the art may also use other functional units in the image forming device 1000 to provide the driving force for the driving member 331 according to actual needs in various embodiments, and the present disclosure has no limit on this. In the image forming device 1000, the developer transmission component 330 may be usually close to the imaging component 310. Therefore, providing driving force for the driving member 331 through the imaging component 310 may make the structure of the image forming device 1000 more compact.

In one embodiment, the driving member 331 may include a tubular connection element 3311, and the tubular connection element 3311 may include a chamber.

Correspondingly, the toggle member 332 may include an axial connection element 3321 matching the tubular connection element 3311, and the axial connection element 3321 may be installed in the chamber of the tubular connection element 3311 to realize the connection between the driving member 331 and the toggle member 332.

Further, the axial connection element 3321 may be provided with protrusions 33211, and the chamber of the tubular connection element 3311 may be provided with recesses (not shown in the figure) matching the protrusions 33211. When the axial connection element 3321 is installed in the tubular connection element 3311, the protrusions 33211 on the axial connection element 3321 may be embedded in the recesses in the chamber of the tubular connection element 3311. It is understandable that when the driving member 331 rotates, the driving member 331 may drive the toggle member 332 to rotate at the same speed through the matching relationship between the protrusions 33211 and the recesses.

In some embodiments, the axial connection element 3321 may include a plurality of protrusions 33211, and the plurality of protrusions 33211 may be arranged at intervals. Correspondingly, a plurality of recesses matching the plurality of protrusions 33211 may be correspondingly arranged in the chamber of the tubular connection element 3311, and the plurality of recesses may be also arranged at intervals. When the axial connection element 3321 is installed in the tubular connection element 3311, the plurality of protrusions 33211 on the axial connection element 3321 may be embedded in the plurality of recesses in the chamber of the tubular connection element 3311, thereby realizing the connection between the driving member 331 and the toggle member 332. It is understandable that when the driving member 331 and the toggle member 332 are connected by the plurality of protrusions 33211 and the plurality of recesses, the connection strength and reliability between the driving member 331 and the toggle member 332 may be improved. For example, the number of the plurality of protrusions 33211 or the plurality of recesses may be 2, 3, 4, etc., and the embodiment of the present disclosure does not specifically limit this.

In some embodiments, the driving member 331 may be detachably connected to the toggle member 332. This detachable connection method may facilitate the maintenance of the developer supply control device 300 and the replacement of parts. Of course, in some other embodiments, the driving member 331 and the toggle member 332 may be configured as one piece according to actual needs. It is understandable that, when the driving member 331 and the toggle member 332 are integrally formed, connecting members between the driving member 331 and the toggle member 332 (for example, the axial connection element 3321, the tubular connection element 3311, the convex portion 33211, the recess, etc.) may be replaced, and the embodiment of the present disclosure does not limit this.

The embodiments shown in FIG. 6 to FIG. 10 with the connection methods between the driving member 331 and the toggle member 332 are used as examples only to illustrate the present disclosure, and do not limit the scope of the present disclosure. For example, in some other embodiments, a shaft-shaped connection element 3321 may be provided on the driving member 331, and a tubular connection element 3311 may be provided on the toggle member 332, to achieve connection between the driving member 331 and the toggle member 332. In yet some other embodiments, an interference fit may be provided between the shaft-shaped connection element 3321 and the tubular connection element 3311, thereby replacing the protrusions 33211 on the shaft-shaped connection element 3321 and the recesses in the chamber of the tubular connection element 3311.

As shown in FIG. 6 to FIG. 8, in some embodiments, the toggle member 332 may further include a toggle blade element 3322 and a spacer 3323. Among them, the toggle blade element 3322 may be connected to the shaft-shaped connection element 3321, and may be used to rotate under the drive of the driving member 331. When the toggle blade element 3322 rotates, the developer in the developer transmission channel 320 may be toggled, such that the developer in the developer transmission channel 320 is transmitted to the imaging component 310. In some other embodiment, the toggle member 332 may include two toggle blade elements 3322, and the two toggle blade elements 3322 may be centrally symmetrically arranged relative to the axis of the shaft-shaped connection element 3321, such that the two toggle blade elements 3322 are in a straight line shape. In other words, the two toggle blade elements 3322 may be spaced 180° apart. Of course, in yet some other embodiments, more or fewer toggle blade elements 3322 may be provided on the toggle member 332 according to actual needs. For example, the number of toggle blade elements 3322 may be 1, 3, 4, 5, etc., and the embodiment of the present disclosure does not impose specific restrictions on this. It should be supplemented that when multiple toggle blades 3322 are set on the toggle member 332, the multiple toggle blades 3322 may be centrally symmetrically arranged relative to the axis of the axial connection element 3321, such that the toggle member 332 may more evenly toggle the developer in the developer transmission channel 320 into the imaging component 310 and the developer is more evenly distributed in the imaging component 310.

The spacer 3323 may be arranged between the toggle blade elements 3322 and the shaft-shaped connection elements 3321, and may be used to block the developer in the developer transmission channel 320 from reaching the shaft-shaped connection element 3321 and causing leakage of the developer. In one embodiment shown in FIG. 6 to FIG. 8, the cross-section of the spacer 3323 may be circular. In some other embodiments, the spacer 3323 may be set to other shapes according to actual needs, and the embodiment of the present disclosure does not impose specific restrictions on this.

As shown in FIG. 5, in one embodiment, the developer supply control device 300 may also include the residual information feedback unit 340, and the residual information feedback unit 340 may be used to send the residual information of the developer in the imaging component 310 to the image forming device 1000. The residual information of the developer may be used to determine whether the imaging component 310 needs to be supplied with developer.

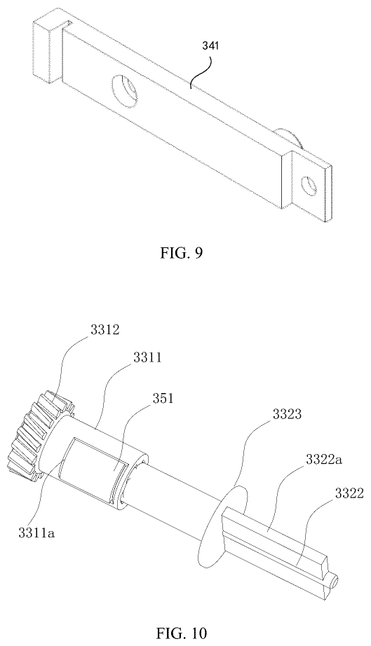

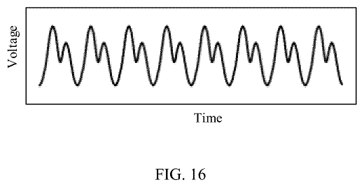

In some embodiments, the residual information feedback unit 340 may include a residual information detection unit, which is used to detect the residual information of the developer in the imaging component 310. For example, in one embodiment, the residual information detection unit may be a developer carrier ratio sensor 341. For example, the developer carrier ratio sensor 341 may be a toner concentration sensor (TC sensor). The toner concentration sensor (TC sensor) is a kind of magnetic flux sensor. The toner concentration sensor (TC sensor) may be provided with a power line, and the power line may be electrically connected to the data board of the image forming device. The data board may include a digital-to-analog converter, and the digital-to-analog converter may convert analog information into a digital signal and transmit the digital information to the processor (SOC) of the image forming device. In one embodiment, the toner concentration sensor (TC sensor) may be arranged on the imaging component 310. When the imaging component 310 is in a working state, the toner concentration sensor (TC sensor) may start the detection work, and the toner concentration sensor (TC sensor) may collect an analog voltage information. The collected analog voltage information may be transmitted to the data board through the power line. The digital-to-analog converter of the data board may convert the analog voltage information into a digital voltage signal, and transmit the converted digital voltage signal to the processor (SOC) of the image forming device. Further, as shown in FIG. 9, the developer carrier ratio sensor 341 may be based on the developer-to-carrier ratio of the imaging component 310 (the developer-to-carrier ratio may reflect whether the imaging component 310 needs to be supplied with developer). For example, the developer-to-carrier ratio here may be understood as the gram weight ratio of the developer to the carrier. For example, the ratio less than or equal to 7% may indicate that the imaging component 310 needs to be supplied with developer, and further, the residual information of the developer in the imaging component 310 (in other parts of the present disclosure, the residual information of the developer may also be referred to as a “residual information detection signal”, and the residual information detection signal here is an analog voltage value) may be generated. As shown in FIG. 16, after obtaining the residual information detection signal, the image forming device 1000 may parse the residual information detection signal, and then determine whether the imaging component 310 needs to be supplied with developer according to the analysis result. For example, the voltage value of the residual information detection signal may be compared with a preset voltage threshold. When the voltage value of the residual information detection signal is larger than or equal to the preset voltage threshold, it may be determined that the imaging component 310 needs to supply developer. When the voltage value of the residual information detection signal is lower than the preset voltage threshold, it may be determined that the imaging component 310 does not need to supply developer. In another embodiment, when the voltage value of the residual information detection signal is larger than the preset voltage threshold, it may be determined that the imaging component 310 does not need to supply developer; and when the voltage value of the residual information detection signal is lower than or equal to the preset voltage threshold, it may be determined that the imaging component 310 needs to supply developer. In some embodiments, after the image forming device prints an image, the processor (SOC) of the image forming device may obtain the number of light spots emitted by the LSU. After obtaining the number of light spots, the processor (SOC) may compare the number of the light spots with the light spot powder consumption value table stored in the storage unit (chips of the SOC) of the image forming device. The processor (SOC) may further use the number of light spots to look up the table to obtain the developer consumption of the imaging component, and accumulate the obtained developer consumption to the consumable chip of the imaging component. The consumable chip may determine the developer residual of the imaging component based on the obtained developer consumption information, that is, the residual information of the developer in the imaging component 310 may be obtained by communicating with the consumable chip of the imaging component. The embodiment of the present disclosure does not limit the method for determining the residual information of the developer in the imaging component 310.

In some other embodiments, the residual information feedback unit may also be a transmission component for transmitting the residual information of the developer in the imaging component 310 to the image forming device 1000. The transmission component may include a connection component for establishing an electrical connection with the image forming device 1000, or may include a conductor for transmitting the residual information of the developer in the imaging component 310. The conductor may be a wire, etc. For example, in one embodiment, the transmission component may be a chip contact for connecting to the image forming device 1000. In another embodiment, one end of the wire may be electrically connected to the transmission component and the other end of the wire may be provided with a plug-in terminal, and the plug-in terminal may be electrically connected to the interface of the image forming device 1000 in a plug-in manner, to realize the transmission of the residual information of the developer in the imaging component 310 to the image forming device 1000.

In some other embodiments, the residual information feedback unit may include the aforementioned residual information detection unit and the aforementioned transmission component. The specific form of the residual information feedback unit is not limited according to various embodiments of the present disclosure.

It is understandable that in the process of supplying developer to the imaging component 310, when the working state of the developer transmission component 330 is unstable (for example, the rotation speed of the developer transmission component 330 is unstable), the developer cannot be evenly supplied to the imaging component 310, and the developer may be unevenly and unstably distributed in the imaging component 310, thereby causing defects such as white spots or color spots to appear in the image formed or even causing polymers to appear in the developer of the imaging component 310. Therefore, in the present disclosure, it may be also necessary to detect the working state of the developer transmission component 330 to determine whether the working state of the developer transmission component 330 is stable.

As shown in FIG. 5, in one embodiment, the developer supply control device 300 may further include a state detection element 350, which is used to detect the working state of the developer transmission component 330 and send the detected working state information (in other parts of this document, the working state information of the developer transmission component 330 may also be referred to as a “working state information detection signal”) to the image forming device 1000. The image forming device 1000 may determine whether to control the developer containing device 100 to supply the developer to the developer transmission channel 320 based on the residual information of the developer in the imaging component and the working state information of the developer transmission component. For example, when the residual information feedback unit detects the residual developer in the imaging component 310 and transmits the residual information of the developer in the imaging component 310 to the image forming device 1000, the image forming device 1000 may determine whether to turn on the state detection element 350 based on the residual information of the developer of the imaging component 310. After the state detection element 350 starts the detection work, the state detection element 350 may be used to detect the working state of the developer transmission component 330. When it is determined that the working state of the developer transmission component 330 is as expected, the developer containing device 100 may be controlled to supply the developer to the developer transmission channel 320 of the developer supply control device 300, and the developer transmission component 330 may be controlled to work to transmit the developer in the developer transmission channel 320 to the imaging component 310.

In one embodiment, the state detection unit may include the state detection element 350 and a photoelectric sensor B (as shown in FIG. 8), and the state detection element may include a reflective element 351 which is disposed on the developer transmission component 330 and is used to reflect the light signal of the external light source to the image forming device 1000. Further, a non-reflective area may be also provided on the developer transmission component 330 (usually, all areas except the area where the reflective element 351 is located are the non-reflective area). When the developer transmission assembly 330 rotates, the light signal of the external light source may be alternately irradiated on the reflective element 351 and the non-reflective area. It can be understood that when the light signal of the external light source is irradiated on the reflective element 351, the reflective element 351 may reflect the light signal to the outside; and when the light signal of the external light source is irradiated on the non-reflective area, the non-reflective area cannot reflect the light signal to the outside.

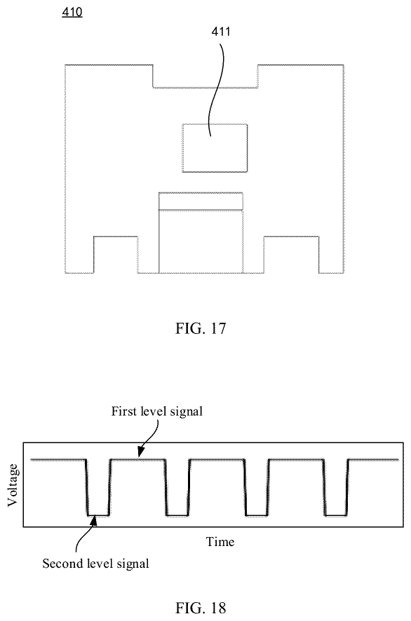

The image forming device 1000 may further include a photoelectric sensor 410. As shown in FIG. 17, a photosensitive area 411 may be provided on the photoelectric sensor 410. The photoelectric sensor 410 may output a corresponding electrical signal according to the light intensity received by the photosensitive area 411. In one embodiment, when the light signal of the external light source is irradiated on the reflective element 351, the reflective element 351 may reflect the light signal to the photosensitive area 411 of the photoelectric sensor 410, such that the photosensitive area 411 obtains a strong light intensity and then outputs a first level signal. When the light signal of the external light source is irradiated on the non-reflective area, the photosensitive area 411 may obtain a weak light intensity (the non-reflective area may have a weak reflective ability, or there is ambient light that causes the photosensitive area 411 to obtain a weak light intensity) and then outputs a second level signal. That is, when the developer transmission component 330 rotates, the light signal of the external light source may be alternately irradiated on the reflective element 351 and the non-reflective area, thereby obtaining the alternating first level signal and second level signal. The alternating first level signal and second level signal may be the working state information detection signal described above. In some other embodiments, when the light signal of the external light source is irradiated on the reflective element 351, the reflective element 351 may reflect the light signal to the photosensitive area 411 of the photoelectric sensor 410, such that the photosensitive area 411 obtains a stronger light intensity and thereby outputs a second level signal; and, when the light signal of the external light source is irradiated on the non-reflective area, the photosensitive area 411 may obtain a weaker light intensity and thereby outputs a first level signal. It should be supplemented that the external light source involved in the embodiments of the present disclosure may be a part of the photoelectric sensor 410 or an independent light source outside the photoelectric sensor 410, and the embodiment of the present disclosure does not impose specific restrictions on this.

FIG. 18 is a waveform diagram of a working state information detection signal provided by an embodiment of the present disclosure. As shown in FIG. 18, the working state information detection signal may include the first level signal and the second level signal that change alternately, where the first level signal is a high level and the second level signal is a low level. It can be understood that the alternating first level signal and the second level signal may be able to reflect the working state of the developer transmission component 330. It can be understood that the working state of the developer transmission component 330 may be the rotation stability of the developer transmission component 330, that is, whether the time for the developer transmission component 330 to rotate one circle is fixed. When the time for the developer transmission component 330 to rotate one circle is fixed, the working state of the developer transmission component 330 may be stable. Further, the image forming device 1000 may parse the working state information detection signal, obtain the parameters such as the period, high level duration, low level duration, high level frequency and/or low level frequency corresponding to the working state information detection signal, and determine whether the working state of the developer transmission component 330 meets expectations based on the above parameters.

Those skilled in the art should understand that as long as the “first level signal” and the “second level signal” are able to be distinguished, the working state of the developer transmission component 330 may be able to be determined by parsing the working state information detection signal. Therefore, in some embodiments, the first level signal may be set to a low level and the second level signal may be set to a high level; or, in some other embodiments, the first level signal and the second level signal may be set to a high level at the same time, and there may be a difference in the voltage magnitudes corresponding to the first level signal and the second level signal, which is not specifically limited in the embodiments of the present disclosure.

In one embodiment, the reflective element 351 may be set on the toggle member 332 of the developer transmission component 330, and reflect the light signal of the external light source to the image forming device 1000 during the rotation of the toggle member 332. It can be understood that according to the setting position of the reflective element 351 on the toggle member 332, the angle at which the reflective element 351 receives the light signal of the external light source may be determined, such that when the toggle member 332 rotates to this angle, the reflective element 351 reflects the light signal of the external light source. Further, when the reflective element 351 is disposed on the toggle member 332, the toggle member 332 may include a first non-reflective area, and the light signal of the external light source may be alternately irradiated to the reflective element 351 and the first non-reflective area when the driving member 331 drives the toggle member 332 to rotate, thereby generating the alternating first level signal and second level signal. For the specific contents of the embodiments of the present disclosure, please refer to the above description, and for the sake of brevity, it will not be repeated here.

In another embodiment, the reflective element 351 may also be arranged on the driving member 331 of the developer transmission component 330. For example, the driving member 331 may be made of a reflective material, and the reflective element 351 and the driving member 331 may be integrally formed. For another example, the driving member 331 may be made of a non-reflective material, and the reflective element 351 may be adhered to the driving member 331 by adhesive and reflect the light signal of the external light source to the image forming device 1000 during the rotation of the driving member 331. According to the setting position of the reflective element 351 on the driving member 331, the angle at which the reflective element 351 receives the light signal of the external light source may be determined, such that the reflective element 351 reflects the light signal of the external light source when the driving member 331 rotates to the angle. Further, when the reflective element 351 is arranged on the driving member 331, the driving member 331 may include a second non-reflective area. When the driving member 331 rotates, the light signal of the external light source may be alternately irradiated to the reflective element 351 and the second non-reflective area, thereby generating the alternating first level signal and second level signal. For the specific contents of the present disclosure, please refer to the above description. For the sake of brevity, they will not be repeated here.

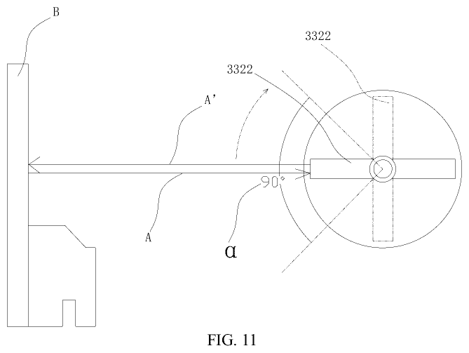

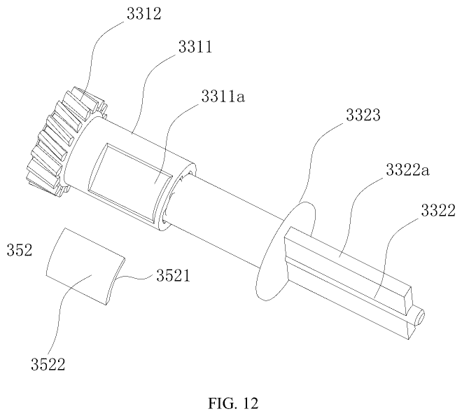

In some embodiments, as shown in FIG. 10 and FIG. 11, the state detection unit may include a reflective element 351 and a photoelectric sensor B. A sticking area 3311a may be provided on the tubular connection element 3311 of the driving member 331. The reflective element 351 may be adhered to the sticking area 3311a of the tubular connection element 3311 of the driving member 331 by adhesive. Along the axial direction of the driving member 331, the reflective element 351 may be parallel to the end face 3322a of the toggle blade element 3322, and reflect the light signal of the external light source to the image forming device 1000 as the driving member 331 rotates. According to the setting position of the reflective element 351 on the driving member 331, the angle at which the reflective element 351 receives the light signal of the external light source may be determined. Preferably, the photoelectric sensor B may include a light source, and the light source may have the same function as the external light source described above. The light source may emit light A. During the process of rotating the toggle blade element 3322 by 0° to 90°, the reflective element 351 may reflect the light A of the light source B, and the photoelectric sensor may receive the light A′ reflected by the reflective element 351, generate a light signal, and convert the light signal into a level signal (or the photoelectric sensor may receive the light A′ reflected by the reflective element 351, and generate a level signal). The driving member 331 may include a second non-reflective area. When the driving member 331 rotates, the light of the light source may alternately irradiate the reflective element 351 and the second non-reflective area, thereby generating the alternating first level signal and second level signal. The alternating first level signal and second level signal may reflect the working state of the developer supply component 330. Further, the state detection unit may detect whether the working state of the developer transmission component is stable. When the working state of the developer transmission component detected by the state detection unit is stable, the image forming device 1000 may instruct that the developer in the developer containing device 100 is able to be supplied to the developer transmission channel 320. When the working state of the developer transmission component detected by the state detection unit is unstable, the image forming device 1000 may not indicate that the developer in the developer containing device 100 is able to be supplied to the developer transmission channel 320.

In some embodiments, the first level signal may be a low level and the second level signal may be a high level. In some other embodiments, the first level signal may be a high level and the second level signal may be a low level. In some other embodiments, the first level signal and the second level signal may both be high levels, but the first level signal may be different from the second level signal. Preferably, the first level signal and the second level signal may be both high levels, for example, the level value of the first level signal may be 0-2500 mV, and the level value of the second level signal may be 3000±200 mV.

In some embodiments, when the reflective element 351 is disposed on the driving member 331, the reflective element 351 may be disposed on the driving member 331 at a position outside the developer transmission channel 320. Since the external light source is usually located outside the developer transmission channel 320, arranging the reflective element 351 outside the developer transmission channel 320 may facilitate the external light source to irradiate the reflective element 351. Further, arranging the reflective element 351 outside the developer transmission channel 320 may also prevent the developer in the developer transmission channel 320 from blocking the reflective element 351, thereby improving the reliability of the developer supply control device 300. Similarly, in one embodiment, when the reflective element 351 is disposed on the toggle member 332, the reflective element 351 may be disposed on the toggle member 332 at a position outside the developer transmission channel 320, such that the external light source is able to irradiate the reflective element 351 and improve the reliability of the developer supply control device 300.

In some other embodiments, because of the special requirements of certain application scenarios, it may be necessary to set the reflective element 351 in the developer transmission channel 320. At this time, to allow the external light source to illuminate the reflective element 351, a light-through port (not shown in the figure) may be opened on the outer wall of the developer transmission channel 320, and the light signal of the external light source may be irradiated into the developer transmission channel 320 through the light-through port. Further, in the axial direction of the developer transmission channel 320, the position of the reflective element 351 on the developer transmission assembly 330 may be opposite to the light-through port, to ensure that the reflective element 351 is able to receive the light signal emitted by the external light source during the rotation of the developer transmission assembly 330. In some embodiments, when the reflective element 351 is set in the developer transmission channel 320, the light source may also be set in the developer transmission channel 320 at the same time. It can be understood that in this case, it may be not necessary to open a light-through port on the outer wall of the developer transmission channel 320.

As shown in FIG. 6 to FIG. 8, in one embodiment, the reflective element 351 may be disposed on the shaft-shaped connection element 3321 of the toggle member 332. When the shaft-shaped connection element 3321 of the toggle member 332 is made of a reflective material, the reflective element 351 and the shaft-shaped connection element 3321 may be formed in one piece. Or, when the shaft-shaped connection element 3321 of the toggle member 332 is made of a non-reflective material, the reflective element 351 may be adhered to the shaft-shaped connection element 3321 by adhesive. It can be understood that when the shaft-shaped connection element 3321 is installed in the chamber of the tubular connection element 3311, the tubular connection element 3311 may cover the shaft-shaped connection element 3321. In this case, to allow the external light source to still illuminate the reflective element 351, a light-transmitting window 33111 may be open on the tubular connection element 3311, and when the axial connection element 3321 is installed in the chamber of the tubular connection element 3311, the light-transmitting window 33111 may overlap the reflective element 351 at least partially. It can be understood that according to this arrangement, the reflective element 351 may be able to receive the light signal emitted by the external light source during the rotation of the toggle member 332. Preferably, the light-transmitting window 33111 may completely overlap with the reflective element 351 to increase the illumination intensity of the light signal.

Further, in one embodiment, the reflective element 351 may be arranged on one protrusion 33211 of the axial connection element 3321, and preferably, the reflective element 351 and the toggle blade element 3322 may be arranged in a straight line. The recess in the chamber of the tubular connection element 3311 may be arranged corresponding to the light-transmitting window 33111. Since when the axial connection element 3321 may be installed in the chamber of the tubular connection element 3311, the protrusion 33211 of the axial connection element 3321 may match the recess in the chamber of the tubular connection element 3311. Therefore, by setting the light-transmitting window 33111 at a position corresponding to the recess in the chamber, it may be ensured that the light-transmitting window 33111 overlaps with the light-reflecting part 351 when the axial connection element 3321 is installed in the chamber of the tubular connection element 3311.

Further, in another embodiment, a plurality of reflective elements 351 may be arranged on the plurality of protrusions 33211 of the axial connection element 3321. And, one, two, or more light-transmitting windows 33111 may be provided on the tubular connection element 3311. The area of the light-transmitting windows 33111 may be adjusted accordingly according to the number of light-transmitting windows 33111, and the recesses in the chamber of the tubular connection element 3311 may be arranged corresponding to the light-transmitting windows 33111. Since the protrusions 3321 of the axial connection element 3321 match the recesses in the chamber of the tubular connection element 3311 when the axial connection element 3321 is installed in the chamber of the tubular connection element 3311, the light-transmitting windows 33111 may be arranged at positions corresponding to the recesses in the chamber, such that the light-transmitting windows 33111 overlap with the reflective elements 351 when the axial connection element 3321 is installed in the chamber of the tubular connection element 3311.

Further, in one embodiment, when two light-transmitting windows 33111 are provided on the tubular connection element 3311, the two light-transmitting windows 33111 may be arranged 180° apart in the circumferential direction.

The reflective element 351 may also be provided at other positions on the toggle member 332 or at other positions on the axial connection element 3321 of the toggle member 332 according to actual needs. The present disclosure has no limit on this.

The present disclosure also provides an adapter 352. The adapter 352 may be detachably mounted on the developer supply control device 300. The developer supply control device 300 may be provided with a mounting area 3311a, and the mounting area 3311a may be used to mount the adapter 352. In one embodiment, the adapter 352 may be a reflective sheet, and the reflective sheet may include a mounting surface 3521 and a reflecting surface 3522. When the adapter 352 is mounted on the developer supply control device 300, the mounting surface 3521 may be mounted on the developer transmission component 330, and the developer transmission component 330 may be at least partially disposed in the developer transmission channel 320. The developer transmission channel 320 may connect the developer containing device 100 and the imaging component 310. The reflective surface 3522 may be used to detect the working state of the developer transmission component 330. When the image forming device 1000 obtains the working state information of the developer transmission component 330, the working state information and the residual information of the developer in the imaging component 310 described above may be used to determine whether to control the developer containing device 100 to supply the developer to the developer transmission channel 320. In another embodiment, the mounting surface 3521 may be disposed opposite to the reflective surface 3522, and the reflective surface 3522 may be used to reflect the light signal of the external light source to the image forming device 1000, such that the image forming device 1000 is able to determine the working state information of the developer transmission component 330 according to the light signal reflected by the reflective surface 3522.

In another embodiment, the adapter 352 may be disposed on the driving member 331 or the toggle member 332 of the developer transmission component 330, and may reflect the light signal of the external light source to the image forming device 1000 during the rotation of the driving member 331 or the toggle member 332.

In another embodiment, a light-through port may be provided on the outer wall of the developer transmission channel 320, and the light signal of the external light source may be irradiated into the developer transmission channel 320 through the light-through port. In the axial direction of the developer transmission channel 320, when the driving member 331 or the toggle member 332 rotates to a preset angle, the reflective surface 3522 of the adapter 352 may be located on the driving member 331 or the toggle member 332 at a position opposite to the light-through port.

In another embodiment, when the adapter 352 is mounted on the developer supply control device 300, the position of the adapter 352 on the driving member 310 or the toggle member 320 may be located outside the developer transmission channel 320.

In another embodiment, when the driving member 331 or the toggle member 332 is rotated to a preset angle, the reflective surface 3522 of the adapter 352 may be used to reflect the light signal of the external light source to the image forming device 1000.

In another embodiment, when the adapter 352 is set on the toggle member 320, the toggle member may include a first non-reflective area. When the driving member 310 drives the toggle member 320 to rotate, the light signal of the external light source may be alternately irradiated to the reflective surface 3522 and the first non-reflective area. Or, when the adapter is set on the driving member 310, the driving member 310 may be provided with a second non-reflective area, and when the driving member 310 rotates under the driving force of the image forming device 1000, the light signal of the external light source may be alternately irradiated to the reflective surface 3522 and the second non-reflective area, and the light signal of the external light source is reflected by the reflective surface 3522 of the adapter 352. The reflective surface 3522 may be used to enable the image forming device 1000 to obtain the first level signal. The light signal of the external light source may be reflected by the first non-reflective area or the second non-reflective area, and the first non-reflective area or the second non-reflective area may be used to enable the image forming device 1000 to obtain the second level signal, and the first level signal and the second level signal are described as above.

In another embodiment, the developer supply control device 300 may include an imaging component 310, a developer transmission channel 320 connecting the developer containing device 100 and the imaging component 310, a developer transmission component 330, a residual information feedback unit, and a working state detection unit 350. The developer transmission component 330 may be at least partially disposed in the developer transmission channel 320 and may transmit the developer in the developer transmission channel 320 supplied by the developer containing device 100 to the imaging component 310. The residual information feedback unit may be used to send the residual information of the developer in the imaging component 310 to the image forming device 1000. The residual information of the developer may be used to determine whether it is necessary to supply developer to the imaging component 310. A state detection unit installation area may be used to install the state detection unit 350, and the state detection unit 350 may be used to detect the working state of the developer transmission component 330. When the image forming device 1000 obtains the working state information, the residual information of the developer and the working state information may be used to determine whether to control the developer containing device 100 to supply the developer to the developer transmission channel 320.

In another embodiment, the state detection unit installation area may be set on the developer transmission component 330.

In another embodiment, the developer transmission component 330 may include a driving member 331. The driving member 331 may receive the driving force of the image forming device 1000, and a toggle member 332 may be connected to the driving member 331. The toggle member 332 may rotate under the drive of the driving member 331, to toggle the developer in the developer transmission channel 320, such that the developer in the developer transmission channel 320 is transmitted to the imaging component 310. The state detection unit installation area may be set on the driving member 331 or the toggle member 332.

In another embodiment, when the state detection unit installation area is used to install the state detection unit 350, the developer transmission component 330 may include a non-reflective area.

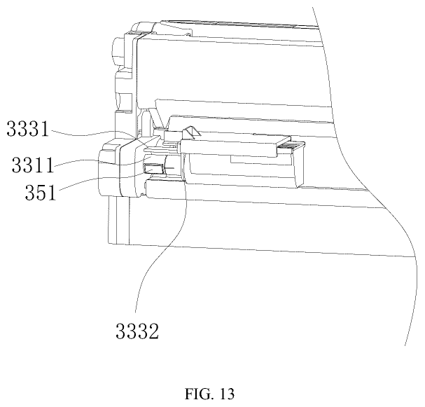

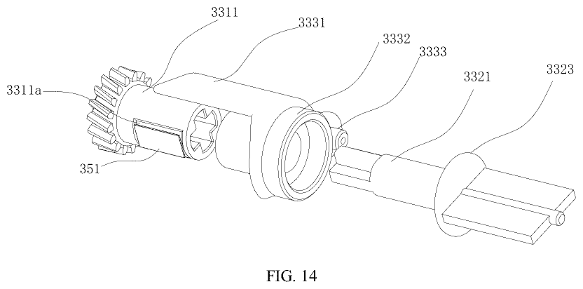

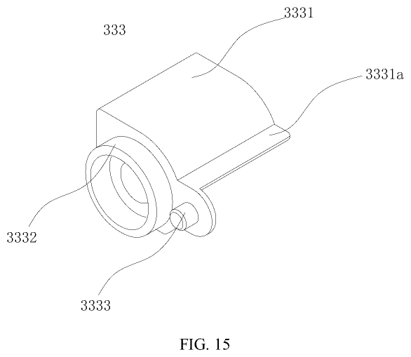

In another embodiment shown in FIG. 13 to FIG. 15, the developer supply control device may also include a protection unit 333. The protection unit 333 may include a cover element 3331, a mounting element 3332, and a positioning element 3333. The mounting element 3332 may be mounted on the axial connection element 3321 of the toggle member 332, and the end surface of the mounting element 3332 may abut against the spacing element 3321 of the toggle member 332. The cover element 3331 may be connected to the mounting element 3332, and the cover element 3331 may cover at least part of the reflective element 351, or the cover element 3331 may cover the entire reflective element 351. The cover element 3331 may protect the reflective element 351 to prevent the developer in the developer containing device 100 from leaking out and falling on the reflective element 351 to affect the detection accuracy. The positioning element 3333 may be connected to the cover element 3331 and the mounting element 3332, and the positioning element 3333 may be connected to the imaging component 310. That is, the positioning element 3333 may be installed on the frame of the imaging component 310, to position the mounting element 3332 and limit the rotation of the mounting element 3332 relative to the toggle member 332 and/or the driving member 331.

In one embodiment, the cover element 3331 of the protection unit 333 may be provided with an extended edge 3331a. The cover element 3331 may be arc-shaped, and the extended edge 3331a may be horizontal, which may further increase the area of the reflective element 351, effectively protect the reflective portion 351, and prevent the developer in the developer containing device 100 from leaking and falling on the reflective element 351 to affect the detection accuracy of the working state of the developer transmission component.

In the present disclosure, the residual information may be detected by the residual information feedback unit, and the working state of the developer transmission component may be detected by the state detection unit, such that the developer supply amount may be accurately controlled and the developer may stably and evenly enter the imaging component 310. Therefore, the image quality of the image forming device 1000 may be improved and the developer in the imaging component 310 may be prevented from being aggregated.

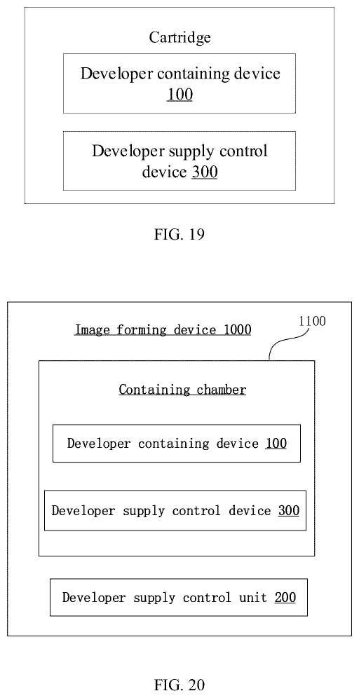

The present disclosure also provides a cartridge. As shown in FIG. 19 which is a structural schematic of an exemplary cartridge provided by the present disclosure, in one embodiment, the cartridge may be detachably mounted to an image forming device 1000, and may include a developer containing device 100 for containing the developer and a developer supply control device 300 provided by various embodiments of the present disclosure.

The present disclosure also provides an image forming device. As shown in FIG. 20, in one embodiment, the image forming device 1000 may include a body 1100, and the body 1100 may include a frame (a housing of the body 1100, not shown in the figure) and a containing chamber 1110. The containing chamber 1110 may be used to receive the developer containing device 100 and the developer supply control device 300 described in the above embodiments.

The image forming device 1000 may also include a developer supply control unit 200. The developer supply control unit 200 may be used to control the developer containing device 100 to supply the developer to the developer transmission channel 320 according to the residual information of the developer in the imaging component 310 and the working state information of the developer transmission component 330 provided by the developer supply control device 300.

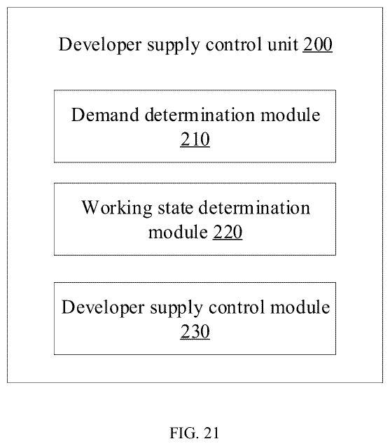

As shown in FIG. 21, in one embodiment, the developer supply control unit 200 may include:

a demand determination module 210, used to determine whether the imaging component 310 needs to be supplied with developer according to the residual information of the developer in the imaging component 310 provided by the developer supply control device 300; a working state determination module 220, used to determine whether the working state of the developer transmission component 330 meets expectations according to the working state information of the developer transmission component 330 provided by the developer supply control device 300; and

a developer supply control module 230, used to control the developer containing device 100 to supply developer to the developer transmission channel 320 of the developer supply control device 300, and control the developer transmission component 330 to work to transmit the developer in the developer transmission channel 320 to the imaging component 310, when the demand determination module 210 determines that the imaging component 310 needs to be supplied with developer and the working state determination module 220 determines that the working state of the developer transmission component 330 meets expectations.

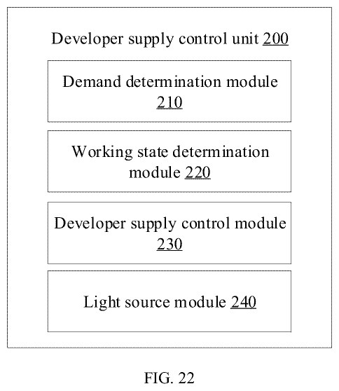

In one embodiment shown in FIG. 22, the developer supply control unit 200 may further include a light source module 240 used to send a first light signal (the “first light signal” can be understood as the light signal emitted by the external light source or light source mentioned above) to the developer supply control device 300 when the demand determination module 210 determines that the imaging component 310 needs to supply developer, such that the working state determination module 220 provides the working state information of the developer transmission component 330 based on the first light signal.

In one embodiment, the working state information of the developer transmission component 330 may further include a second light signal (the second light signal may be understood as the light signal reflected by the reflective element mentioned above). The working state determination module may determine whether the working state of the developer transmission component meets expectations according to the waveform characteristics of the second light signal.

It should be pointed out that the light source module 240 in the embodiment of the present application belongs to the same concept as the “external light source” or “light source” mentioned above. For the convenience of description, different expressions are used in this disclosure.

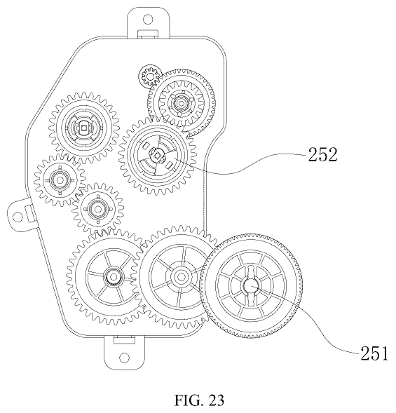

In one embodiment, the image forming device 1000 may further include a first driving unit 251 and a second driving unit 252, as shown in FIG. 23. The first driving unit 251 may be used to respond to the user's operation on the image forming device 1000 and drive the imaging component 310 to work. The second driving unit 252 may be used to drive the developer containing device 100 to supply the developer to the developer transmission channel 320 of the developer supply control device 300.

In one embodiment, the second driving unit 252 may be driven by the first driving unit 251. In some other embodiments, the second driving unit 252 may also be driven separately. The present disclosure has no limit on this.

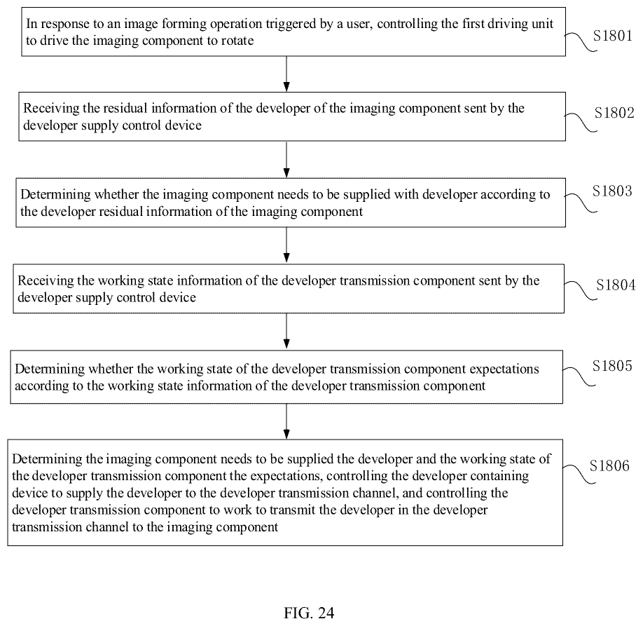

The present disclosure also provides a developer supply control method. The method may be applied to the image forming device, and the developer containing device and the developer supply control device provided by various embodiments of the present disclosure may be installed on the image forming device. As shown in FIG. 24, in one embodiment, the developer supply control method may include:

S1801: in response to an image forming operation triggered by a user, controlling the first driving unit to drive the imaging component to rotate;

S1802: receiving the residual information of the developer of the imaging component sent by the developer supply control device;

S1803: determining whether the imaging component needs to be supplied with developer according to the developer residual information of the imaging component;

S1804: receiving the working state information of the developer transmission component sent by the developer supply control device;

S1805: determining whether the working state of the developer transmission component meets expectations according to the working state information of the developer transmission component; and

S1806: when it is determined that the imaging component needs to be supplied with developer and the working state of the developer transmission component meets the expectations, controlling the developer containing device to supply the developer to the developer transmission channel of the developer supply control device, and controlling the developer transmission component of the developer supply control device to work to transmit the developer in the developer transmission channel to the imaging component.

During the image forming operation, the determinations of whether the developer needs to be supplied and whether the working state of the developer transmission component meets the expectations may be performed respectively. The developer may be supplied to the imaging component only when the imaging component needs to be supplied with developer and the working state of the developer transmission component meets the expectations, to ensure that the developer is able to stably and evenly enter the imaging component, improve the image quality of the image forming device, and avoid the polymerization of the developer in the imaging component.

In one embodiment, when it is determined that the imaging component needs to be supplied with developer, but it is determined that the working state of the developer transmission component does not meet the expectations, a first error message may be output.

In one embodiment, whether the working state of the developer transmission component meets the expectations may be determined based on the working state information of the developer transmission component. Further, whether the working state of the developer transmission component is stable may be determined based on the working state information of the developer transmission component. When the working state of the developer transmission component is unstable, it may be determined that the working state of the developer transmission component does not meet the expectations.

In one embodiment, when it is determined that the working state of the developer transmission component does not meet the expectations, a first error prompt message may be output to prompt the user to check the image forming device.

The method shown in FIG. 24 may be the developer supply control method before performing the image forming operation. In one embodiment, after the image forming device starts (for example, in the preheating stage), the working state of the developer transmission component may be checked first, such that the image forming operation may be quickly performed after containing the image forming operation triggered by the user.

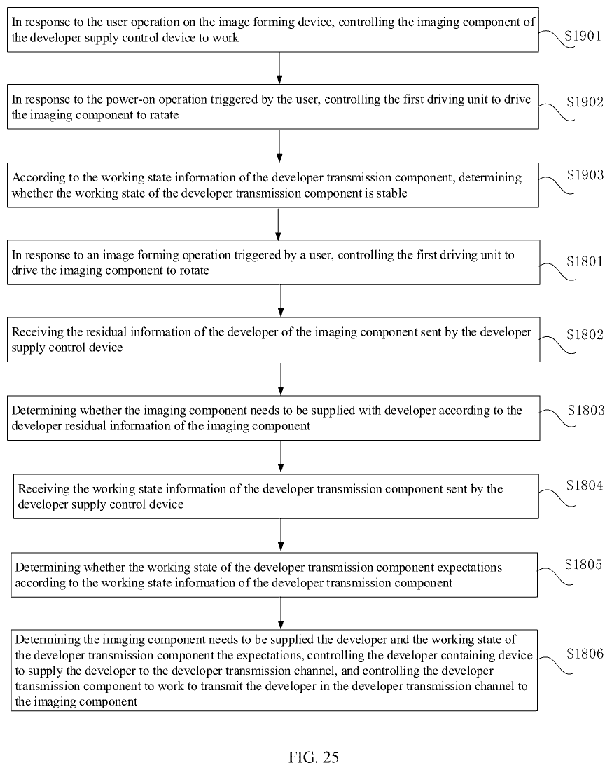

As shown in FIG. 25, in one embodiment, the method further includes:

S1901: in response to the user's operation on the image forming device, controlling the imaging component of the developer supply control device to work;

S1902: in response to the power-on operation triggered by the user, controlling the first driving unit to drive the imaging component to rotate; and

S1903: according to the working state information of the developer transmission component, determining whether the working state of the developer transmission component is stable. When the working state of the developer transmission component is unstable, it may be determined that the working state of the developer transmission component does not meet the expectations.

In one embodiment, when it is determined that the working state of the developer conveying component meets the expectations, the developer supply ready state may be entered such that the image forming device performs the image forming operation based on the user's trigger. When it is determined that the working state of the developer conveying component does not meet the expectations, a second error prompt message may be output to prompt the user to check the image forming device.

The present disclosure also provides a computer-readable storage medium. The storage medium may include a stored program. When the program is running, a device where the storage medium is located may be controlled to execute a developer supply control method provided by various embodiments of the present disclosure. For detailed description, the reference may be made to the above embodiments of the program installation method. The computer-readable storage medium may be a magnetic disk, an optical disk, a read only memory (ROM), or a random access memory (RAM), etc.

The present disclosure also provides a computer program product. The computer program product may include executable instructions. When the executable instructions are executed by a computer, the computer may be controlled to execute a developer supply control method provided by various embodiments of the present disclosure.

The embodiments disclosed herein are exemplary only. Other applications, advantages, alternations, modifications, or equivalents to the disclosed embodiments are obvious to those skilled in the art and are intended to be encompassed within the scope of the present disclosure. In some cases, the actions or steps recited in the present disclosure may be performed in an order different from that in the embodiments and still achieve desirable results. In addition, the processes depicted in the accompanying figures do not necessarily require the particular order shown, or sequential order, to achieve desirable results. Multitasking and parallel processing may be also possible or may be advantageous in certain embodiments.

Any process or method descriptions in flowcharts or otherwise described herein may be understood to represent modules, segments or portions of code comprising one or more executable instructions for implementing custom logical functions or steps of a process, and the scope of preferred embodiments of this specification includes alternative implementations in which functions may be performed out of the order shown or discussed, including in substantially simultaneous fashion or in reverse order depending on the functions involved.

In the present disclosure, the disclosed systems, devices or methods can be implemented in other ways. For example, the device embodiments described above are only illustrative. For example, the division of the units is only a logical function division. In actual implementation, there may be other division methods. For example, multiple units or components may be combined or may be integrated into another system, or some features may be ignored or not implemented. In another point, the mutual coupling or direct coupling or communication connection shown or discussed may be through some interfaces, and the indirect coupling or communication connection of devices or units may be in electrical, mechanical or other forms. Each functional unit in each embodiment of the present disclosure may be integrated into one processing unit, or each unit may exist separately physically, or two or more units may be integrated into one unit. The above-mentioned integrated units can be implemented in the form of hardware, or in the form of hardware plus software functional units.

The integrated units implemented in the form of software functional units may be stored in a non-transitory computer-readable storage medium. The above-mentioned software functional units may be stored in a storage medium, including several instructions to enable a computer device (which may be a personal computer, a connector, or a network device, etc.) or a processor to execute a portion of the methods described in each embodiment of the present disclosure. The aforementioned storage media may include medium that can store program code such as a flash disk, a mobile hard disk, read-only memory (ROM), random access memory (RAM), magnetic disk or optical disc, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A developer supply control device, comprising:
an imaging component;
a developer transmission channel for connecting a developer containing device and the imaging component;
a developer transmission component, at least partially disposed in the developer transmission channel and used to transmit developer in the developer transmission channel supplied from the developer containing device to the imaging component;
a residual information feedback unit, used to send residual information of the developer in the imaging component to an image forming device, wherein the residual information of the developer is used to determine whether the developer needs to be supplied to the imaging component; and
a state detection unit, used to detect a working state of the developer transmission component, wherein: when the image forming device acquires the working state information, the residual information of the developer and the working state information are used to determine whether to control the developer containing device to supply the developer to the developer transmission channel.

2. The device according to claim 1, wherein:
the state detection unit includes a reflective element;
the reflective element is arranged on the developer transmission component and is used to reflect a light signal of an external light source to the image forming device, such that the image forming device is able to determine the working state information of the developer transmission component based on the light signal reflected by the reflective element.

3. The device according to claim 2, wherein:
the developer transmission component includes: a driving member for receiving a driving force of the image forming device; and a toggle member connected to the driving member, wherein the toggle member is used to rotate under the drive of the driving member to toggle the developer in the developer transmission channel such that the developer in the developer transmission channel is transmitted to the imaging component; and
the reflective element is disposed on the driving member or the toggle member, and reflects the light signal of the external light source toward the image forming device during the rotation of the driving member or the toggle member.

4. The device according to claim 3, wherein:
a light-through port is provided on an outer wall of the developer transmission channel, and the light signal of the external light source is irradiated into the developer transmission channel through the light-through port; and
in an axial direction of the developer transmission channel, when the driving member or the toggle member is rotated to a preset angle, the position of the reflective element on the driving member or the toggle member is opposite to the light-through port.

5. The device according to claim 3, wherein:
the reflective element is arranged at a position on the driving member or the toggle member outside the developer transmission channel.

6. The device according to claim 3, wherein:
when the driving member or the toggle member rotates to a preset angle, the reflective element is used to reflect the light signal of the external light source to the image forming device.

7. The device according to claim 3, wherein:
when the driving member or the toggle member rotates to a preset angle, the working state information of the developer transmission component detected by the state detection unit is used to indicate that the developer in the developer containing device is able to be supplied to the developer transmission channel.

8. The device according to claim 3, wherein:
when the reflective element is arranged on the toggle member, the toggle member includes a first non-reflective area, and when the driving member drives the toggle member to rotate, the light signal of the external light source is alternately irradiated to the reflective element and the first non-reflective area; or, when the reflective element is arranged on the driving member, the driving member is provided with a second non-reflective area, and when the driving member rotates under the driving force of the image forming device, the light signal of the external light source is alternately irradiated to the reflective element and the second non-reflective area; and
the light signal of the external light source is reflected by the reflective element, and the reflective element is used to enable the image forming device to obtain a first level signal; and the light signal of the external light source is reflected by the first non-reflective area or the second non-reflective area, and the first non-reflective area or the second non-reflective area is used to enable the image forming device to obtain a second level signal.

9. The device according to claim 3, wherein:
the toggle member includes:
an axial connection element, used to be connected to the driving member;
a toggle blade element, connected to the axial connection element and used to rotate under the drive of the driving member to toggle the developer in the developer transmission channel such that the developer in the developer transmission channel is transmitted to the imaging component; and
a spacer, arranged between the toggle blade element and the axial connection element, and used to block the developer in the developer transmission channel from reaching the axial connection element;
the driving member includes a tubular connection element, and the tubular connection element is provided with a chamber for mounting the shaft-shaped connection element;
the axial connection element includes a protrusion for cooperating with a recess in the chamber of the tubular connection element.

10. The device according to claim 9, wherein:
the shaft-shaped connection element includes a plurality of protrusions, wherein: the plurality of protrusions is arranged at intervals; and
a plurality of recesses is correspondingly arranged in the chamber of the tubular connection element for cooperating with the plurality of protrusions;
the plurality of protrusions arranged at intervals is cross-shaped; and
the driving member and the toggle member are detachably connected; or the driving member and the toggle member are integrally formed.

11. The device according to claim 3, further including a protection unit, wherein:
the protection unit is mounted on the developer transmission component to protect the developer transmission component; or the protection unit is mounted on the toggle member and is used to protect the reflective element; and
the protection unit includes:
a mounting element, mounted on the toggle member;
a cover element, connected to the mounting element and used to cover at least part of the reflective element; and
a positioning element, connected to the imaging component and used to position the mounting element and limit the mounting element from rotating relative to the toggle member and/or the driving member.

12. The device according to claim 11, wherein:
the reflective element is disposed on the driving member or the toggle member by adhesive, and reflects the light signal of the external light source toward the image forming device during the rotation of the driving member or the toggle member.

13. An image forming device, comprising:
a main body including a frame and a containing chamber, wherein the containing chamber is used to accommodate a developer containing device and a developer supply control device, wherein:
the developer supply control device includes:
an imaging component;
a developer transmission channel for connecting the developer containing device and the imaging component;
a developer transmission component, at least partially disposed in the developer transmission channel and used to transmit developer in the developer transmission channel supplied from the developer containing device to the imaging component;
a residual information feedback unit, used to send residual information of the developer in the imaging component to the image forming device, wherein the residual information of the developer is used to determine whether the developer needs to be supplied to the imaging component; and
a state detection unit, used to detect a working state of the developer transmission component, wherein: when the image forming device acquires the working state information, the residual information of the developer and the working state information are used to determine whether to control the developer containing device to supply the developer to the developer transmission channel,
and
a developer supply control unit, used to control the developer containing device to supply the developer to the developer transmission channel based on residual information of the developer in the imaging component and working state information of the developer transmission component of the developer supply control device.

14. The image forming device according to claim 13, wherein:
the developer supply control unit includes:
a demand determination module, used to determine whether the imaging component needs to be supplied with the developer based on the residual information of the developer in the imaging component provided by the developer supply control device;
a working state determination module, used to determine whether the working state of the developer transmission component meets expectations based on the working state information of the developer transmission component;
a developer supply control module, used to control the developer containing device to supply the developer to the developer transmission channel of the developer supply control device when the demand determination module determines that the imaging component needs to be supplied with developer and the working state determination module determines that the working state of the developer transmission component meets the expectations, and control the developer transmission component to transmit the developer in the developer transmission channel to the imaging component.

15. The image forming device according to claim 14, further including a light source module, wherein:
the light source module is used to send a first light signal to the developer supply control device when the demand determination module determines that the imaging component needs to be supplied with developer, such that the working state determination module provides the working state information of the developer transmission component based on the first light signal.

16. The image forming device according to claim 15, wherein:
the working state information of the developer transmission component includes a second light signal; and
the working state determination module determines whether the working state of the developer transmission component meets the expectations according to the characteristics of the second light signal.

17. The image forming device according to claim 13, further including:
a first driving unit, used to drive the imaging component to work; and
a second driving unit, used to drive the developer containing device to supply the developer to the developer transmission channel of the developer supply control device.

18. A developer supply control device, comprising:
an imaging component;
a developer transmission channel for connecting a developer containing device and the imaging component;
a developer transmission component, at least partially disposed in the developer transmission channel and used to transmit the developer in the developer transmission channel supplied from the developer containing device to the imaging component;
a residual information feedback unit, used to send residual information of the developer in the imaging component to an image forming device, wherein the residual information of the developer being used to determine whether the developer needs to be supplied to the imaging component; and
a state detection unit installation area, used to install a state detection unit, wherein the state detection unit is used to detect a working state of the developer transmission component, and when the image forming device acquires the working state information, the residual information of the developer and the working state information are used to determine whether to control the developer containing device to supply the developer to the developer transmission channel.

19. The developer supply control device according to claim 18, wherein:
the state detection unit installation area is disposed on the developer transmission component.

20. The developer supply control device according to claim 19, wherein:
the developer transmission component includes:
a driving member for receiving the driving force of the image forming device; and
a toggle member connected to the driving member, wherein the toggle member is used to rotate under the drive of the driving member and toggle the developer in the developer transmission channel such that the developer in the developer transmission channel is transmitted to the imaging component,
wherein:
the state detection unit installation area is set on the driving member or the toggle member;
when the state detection unit installation area is used to install the state detection unit, the developer transmission component includes a non-reflective area.
